(19) United States
(12) Patent Application Publication
(10) Pub. No.: US 2024/0140004 A1
(43) Pub. Date: May 2, 2024

(54) PRESS MOLDING METHOD OF GLASS OPTICAL ELEMENT

(71) Applicant: NALUX CO., LTD., Osaka (JP)

(72) Inventors: Kei OKADA, Kizugawa-shi (JP); Takehiko YAMAGUCHI, Kizugawa-shi (JP)

(73) Assignee: NALUX CO., LTD., Osaka (JP)

(21) Appl. No.: 18/409,942

(22) Filed: Jan. 11, 2024

Related U.S. Application Data
(63) Continuation of application No. PCT/JP2021/030573, filed on Aug. 20, 2021.

(51) Int. Cl. B29C 43/14; B29C 43/00; B29C 43/52

(52) U.S. Cl. CPC B29C 43/14; B29C 43/003; B29C 43/52; B29K 2096/00

(57) ABSTRACT

A press molding method of a glass optical element using a mold, the method including plural steps with pressurizing, in each of which load is imposed on a piece of glass material at a temperature above the glass transition temperature, and a step without pressurizing between two steps with pressurizing, wherein in a step without pressurizing between a first step with pressurizing and a second step with pressurizing, the second step with pressurizing being the next step with pressurizing after the first step with pressurizing, the temperature of the mold is reduced by 50 degrees centigrade or greater with respect to the temperature of the mold in the first step with pressurizing and then the mold is heated before the start of the second step with pressurizing.

### CROSS REFERENCE TO RELATED APPLICATION

This is a Continuation of International Patent Application No. PCT/JP2021/030573 filed August 20, 2021, which designates the U.S. The contents of this application is hereby incorporated by reference.

### TECHNICAL FIELD

The present invention relates to a press molding method of a glass optical element.

### BACKGROUND ART

When optical glass elements, particularly those which are required to be shaped with a high accuracy, are formed through press molding, gas generated in an enclosed space between the mold surface and the glass material tend to affect the accuracy of the shape With this being the situation, when glass material undergoes molding by a glass mold press machine to mold an optical element, molding methods in which a step in which pressurizing is carried out and a step in which pressurizing is not carried out are alternately repeated to discharge the gas in the enclosed space between the mold surface and the glass material have been developed (Patent document 1, for example). However, for a lens of which the sag is relatively great and the radius of curvature is relatively small, a desired shape with a sufficiently high accuracy cannot be obtained through such conventional methods as described above.

Accordingly, there is a need for a press molding method of a glass optical element by which a desired shape of the element with a sufficiently high accuracy can be obtained independently of the shape of the element.

### PRIOR ART DOCUMENT

### Patent Document

Patent Document 1: JPH07315855(A)

The object of the present invention is to provide a press molding method of a glass optical element by which a desired shape of the element with a sufficiently high accuracy can be obtained independently of the shape of the element.

### SUMMARY OF THE INVENTION

A press molding method of a glass optical element using a mold, the method including plural steps with pressurizing, in each of which load is imposed on a piece of glass material at a temperature above the glass transition temperature, and a step without pressurizing between two steps with pressurizing. In a step without pressurizing between a first step with pressurizing and a second step with pressurizing, the second step with pressurizing being the next step with pressurizing after the first step with pressurizing, the temperature of the mold is reduced by 50 degrees centigrade or greater with respect to the temperature of the mold in the first step with pressurizing and then the mold is heated before the start of the second step with pressurizing.

In the press molding method according to the present invention, because of a difference in thermal contraction between the piece of glass material and the mold, the thermal contraction being caused by reducing the temperature of the mold by 50 degrees centigrade or greater with respect to the temperature of the mold in the first step, the gap between both of them is widened and therefore discharge of gas in the enclosed space between both of them is facilitated in a step without pressurizing. Further, in the press molding method according to the present invention, a condition develops, in which the shape of the portion near the surface of the piece of glass material can be relatively easily altered, and therefore the piece of glass material can be easily molded into the shape of the mold cavity. As a result, a glass optical element shaped with a sufficiently high accuracy can be obtained by the press molding method according to the present invention.

In the press molding method of a glass optical element according to a first embodiment of the present invention, the temperature of the mold is reduced to a temperature below the glass transition temperature in a step without pressurizing.

In the press molding method of a glass optical element according to a second embodiment of the present invention, a value of load imposed in the second step with pressurizing is equal to or greater than a value of load imposed in the first step with pressurizing.

In the press molding method of a glass optical element according to a third embodiment of the present invention, a value of load imposed in the second step with pressurizing is greater than a value of load imposed in the first step with pressurizing.

In the press molding method of a glass optical element according to a fourth embodiment of the present invention, the temperature of the mold is reduced by an amount that is equal to or smaller than 15 degrees centigrade in a step with pressurizing before transition from the step with pressurizing to a step without pressurizing.

By reducing the temperature of the mold before transition from a step with pressurizing to a step without pressurizing, the viscosity of the piece of glass material becomes higher and therefore a possible undesirable change in shape that may take place when the load is removed can be effectively prevented.

### BRIEF DESCRIPTION OF DRAWINGS

FIG. 1 shows an example of a glass mold press machine with which a press molding method of a glass optical element according to the present invention is carried out;

FIG. 2 shows a heater apparatus and a cooling apparatus for the mold;

FIG. 3 illustrates sensors attached to the press machine;

FIG. 4 is a flowchart describing a process of a press molding method of a glass optical element according to the present invention;

FIG. 5 shows a change in the shaft position of the press machine, a change in load of the press machine and a change in temperature of the mold in the process of a press molding method of a glass optical element according to the present invention;

FIG. 6 shows the piece of glass material, the upper die and the lower die during a cooling period (step S1020) in a step without pressurizing in a press molding method of a glass optical element according to the present invention;

FIG. 7 shows the piece of glass material, the upper die and the lower die in a step without pressurizing in a conventional press molding method of a glass optical element;

FIG. 8 shows the piece of glass material, the upper die and the lower die at the start of step S1040 with pressurizing, that is, at the point in time t1′ in FIG. 5 in a press molding method of a glass optical element according to the present invention;

FIG. 9 shows the piece of glass material, the upper die and the lower die at the start of a step with pressurizing in a conventional press molding method of a glass optical element; and

FIG. 10 shows an example of linear expansion of glass and that of a mold.

### DESCRIPTION OF EMBODIMENTS

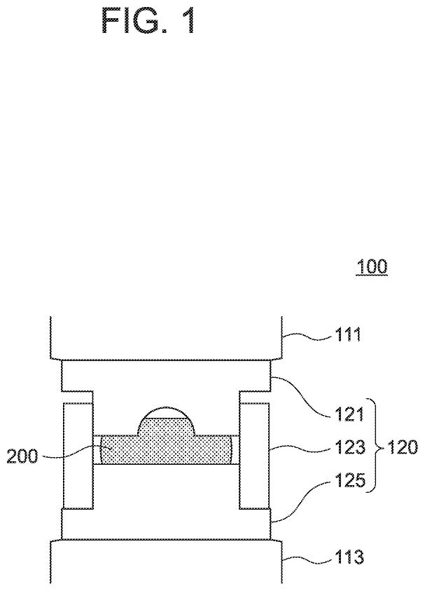

FIG. 1 shows an example of a glass mold press machine with which a press molding method of a glass optical element according to the present invention is practiced. The glass mold press machine is referred to as the press machine hereinafter. The press machine 100 includes a mold 120, an upper shaft for pressurizing 111 and a lower shaft for pressurizing 113. The upper shaft for pressurizing 111 and the lower shaft for pressurizing 113 are referred to respectively as the upper shaft 111 and the lower shaft 113. The mold 120 includes an upper mold die 121, a lower mold die 125 and a guide 123. The upper mold die 121 and the lower mold die 125 are referred to respectively as the upper die 121 and the lower die 125 herein after. The upper shaft 111 is immovable. The lower die 125 is made to move upward by moving the lower shaft 113 by a servomotor not shown in the drawing in order to make a piece of glass material 200 undergo molding using the upper die 121 and the lower die 125.

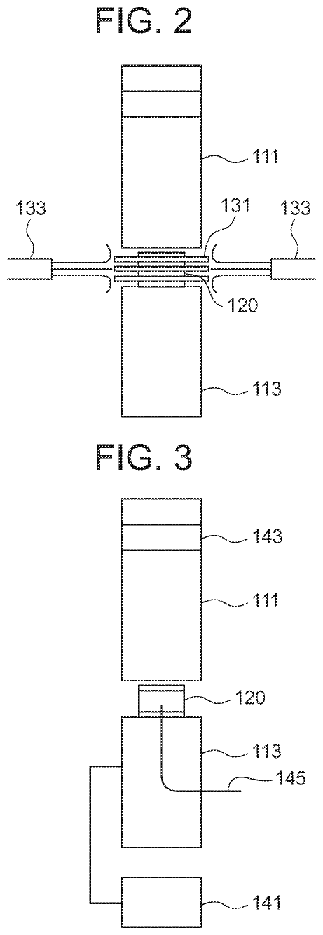

FIG. 2 shows a heating apparatus and a cooling apparatus for the mold 120. The mold 120 can be heated by a high-frequency induction heating coil 131. The mold 120 can be cooled using nitrogen gas blown thereagainst through a nozzle 133. The mold 120 can be heated and cooled by any other means such as an electric heater, a cooler of a water-cooling type or the like.

FIG. 3 illustrates sensors attached to the press machine 100. Temperature of the mold 120 is measured by a thermocouple 145. Load imposed on the upper shaft 111 is measured by a load cell 143. Displacement of the lower shaft 113 is measured by an encoder 141 of the servomotor.

In general, when a piece of glass material undergoes molding by a glass mold press machine to mold an optical element, a step in which pressurizing is carried out and a step in which pressurizing is not carried out are alternately repeated to discharge the gas in the enclosed space between the piece of glass material and the mold surface as described above (Patent document 1, for example). In this case, the temperature of the glass material is kept above the transition temperature while a step in which pressurizing is carried out and a step in which pressurizing is not carried out are alternately repeated. Further, in general, an area of a cross section of an object to be molded, the cross section being perpendicular to the shafts for pressurizing, increases as the molding process proceeds and therefore the load imposed on the object to be molded is made to increase so as to keep a pressure acting on the object to be molded constant.

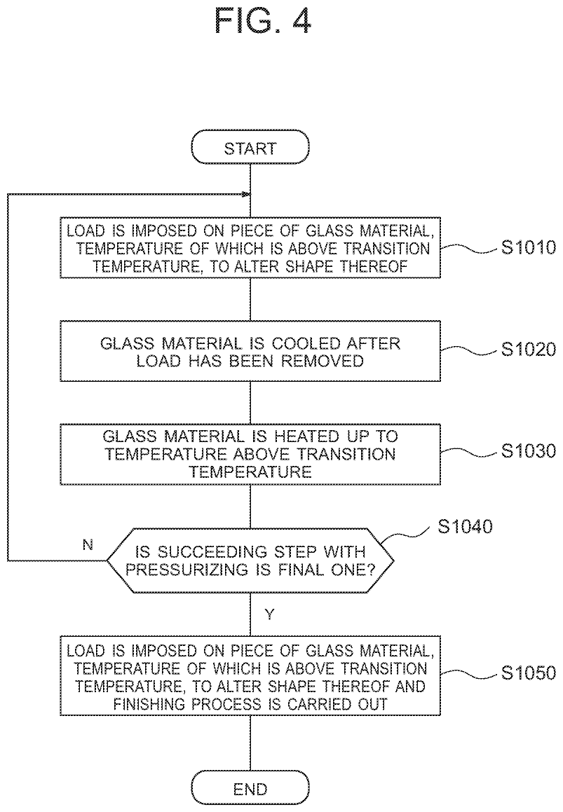

FIG. 4 is a flowchart describing a process of a press molding method of a glass optical element according to the present invention.

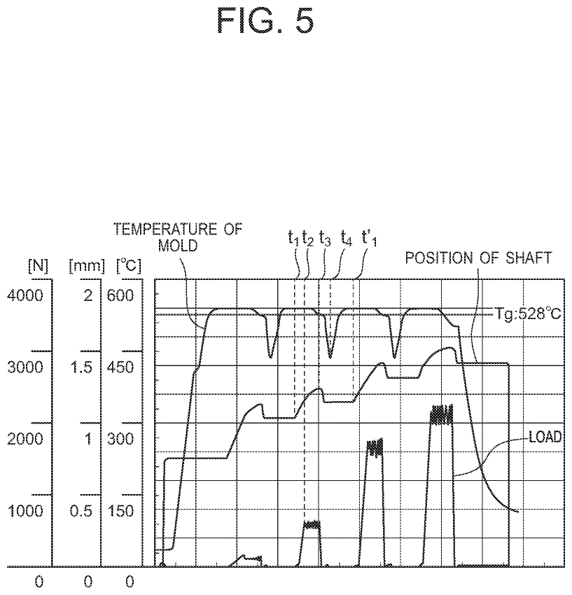

FIG. 5 shows a change in the shaft position of the press machine, a change in load of the press machine and a change in temperature of the mold in the process of a press molding method of a glass optical element according to the present invention. In FIG. 5, the transition temperature of glass is represented by Tg. The glass material is dense lanthanum flint.

In step S1010 of FIG. 4, load is imposed by the press machine 100 on a piece of glass material 200, temperature of which is above the transition temperature, to alter the shape thereof.

At the point in time represented by t1 in FIG. 5, by which time the temperature of the mold 120 has been kept at a predetermined temperature above the transition temperature for a predetermined time period, lifting of the lower shaft 113 is started to start pressing. Since by the point in time t1 the mold 120 has been kept at the predetermined temperature above the transition temperature for the predetermined time period, the temperature of the glass material 200 has become above the transition temperature.

After the start of pressing the load reaches a predetermined value at the point in time represented by t2 in FIG. 5, and after that lifting of the lower shaft 113 is continued while keeping the load at the predetermined value. Till the point in time represented by t3 in FIG. 5, by which time the position of the lower shaft 113 has reached a predetermined value, the load is kept at the predetermined value. At the point in time t3, lowering of the lower shaft 113 is started. As a result, the load becomes zero. The period of time between the point in time t1 and the point in time t3 corresponds to step S1010 in FIG. 4. Step S1010 is referred to as a step with pressurizing.

In step S1020 of FIG. 4, the piece of glass material 200 is cooled through cooling of the mold 120 using the nozzle 133 after the load has been removed. The cooling of the mold 120 using the nozzle 133 is carried out in such a way that the temperature of the mold 120 cooled becomes lower by a predetermined amount of temperature than the temperature of the mold 120 in the step with pressurizing (the temperature of the mold 120 at the point in time t1 and at the point in time t2). In the present example, the predetermined amount of temperature is approximately 100 degrees centigrade. At the point in time t4 in FIG. 5, the temperature of the mold 120 is lower than the temperature in the step with pressurizing by approximately 100 degrees centigrade and lower than the transition temperature of the glass. The period of time between the point in time t3 and the point in time t4 corresponds to step S1020 in FIG. 4. The cooling rate in step S1020 should preferably be made as great as possible from the stand point of efficiency.

As the temperature of the mold 120 changes, the temperature of the glass material 200 also changes. When the temperature of the mold 120 is kept for a predetermined time period, the temperature of the glass material 200, at least the surface thereof, becomes equal to the temperature of the mold 120. According to the findings of the inventors of the present invention, the temperature of the cooled mold 120 should be made lower by 50 degrees centigrade or greater than the temperature of the mold 120 in the step with pressurizing (the temperature of the mold 120 at the point in time t1 and at the point in time t2) in order to obtain effects of the present invention. An amount of change in temperature described above will be described later.

The present invention can be carried out based on the temperature of a heater instead of the temperature of a mold. Even when the present invention is carried out based on the temperature of a heater, the amount of change in temperature is identical.

In the example shown in FIG. 5, the mold 120 is allowed to cool slowly by adjusting the high-frequency induction heating coil 131 during the time period between the point in time t2 and the point in time t3. In the example shown in FIG. 5, the point in time t3 at which lowering of the lower shaft 113 is started is determined in such away that the time period of the slow cooling is appropriate. An amount of decrease in temperature of the mold caused by the slow cooling is approximately 15 degrees centigrade. The decrease in temperature of the mold during a step with pressurizing makes the viscosity of the glass material greater and an effect of preventing a possible undesirable change in shape that may be generated when the load is removed can be achieved. The slow cooling process described above during a step with pressurizing can be omitted.

In step S1030 of FIG. 4, the glass material is heated up to a temperature above the transition temperature.

At a predetermined point in time prior to the point in time t4, heating of the mold 120 by the high-frequency induction heating coil 131 is started. “A predetermined point in time prior to the point in time t4” means a point in time by which time the mold 120 has been cooled to a temperature that is higher by a predetermined amount than a target minimum temperature in a step without pressurizing. “A step without pressurizing” will be described later. The temperature that is higher by a predetermined amount than a target minimum temperature is determined in consideration of the heat capacity of the mold 120 in such a way that the temperature of the mold 120 will fall to the target minimum temperature. Then the temperature of the mold 120 is raised by the high-frequency induction heating coil 131 and after that the temperature of the mold 120 is kept at a temperature above the transition temperature for a predetermined time. The predetermined time described above is determined in such a way that at least the portion near the surface of the glass material 200 becomes above the transition temperature.

The period of time between the point in time t4 and the point in time represented by t1′ in FIG. 5 corresponds to step S1030 in FIG. 4. The point in time t1′ is the point in time at which the succeeding step with pressurizing is started. The succeeding step with pressurizing will be described later.

During step S1020 and step S1030 load is not imposed on the glass material 200. A set of steps S1020 and S1030 is referred to as a step without pressurizing.

In step S1040 of FIG. 4, it is determined whether the succeeding step with pressurizing is the final one or not. If the succeeding step with pressurizing is not the final one, the process goes back to step S1010 and at the point in t1′, by which time the temperature of the mold 120 has been kept at a predetermined temperature above the transition temperature for a predetermined time period, the succeeding step with pressurizing is started. In this way a step with pressuring and a step without pressuring are alternately repeated. If the succeeding step with pressurizing is the final one, the process goes to step S1050.

The number of repetitions of steps with pressurizing is empirically determined in advance. If the number is reached by the succeeding step with pressurizing, the succeeding step with pressurizing is regarded as the final one.

In step S1050 of FIG. 4, at the point in t1′, by which time the temperature of the mold 120 has been kept at a predetermined temperature above the transition temperature for a predetermined time period, lifting of the lower shaft 113 is started to start the final step with pressurizing. Load is imposed by the press machine 100 on the piece of glass material 200, temperature of which is above the transition temperature, to alter the shape thereof and after that a finishing process is carried out. In the finishing process, heating by the high-frequency induction heating coil 131 is suspended and after that the mold 120 is cooled by blowing nitrogen gas using the nozzle 133 to a temperature at which the mold 120 can be removed.

An amount of change in temperature between a step with pressurizing and a step without pressurizing will be described below.

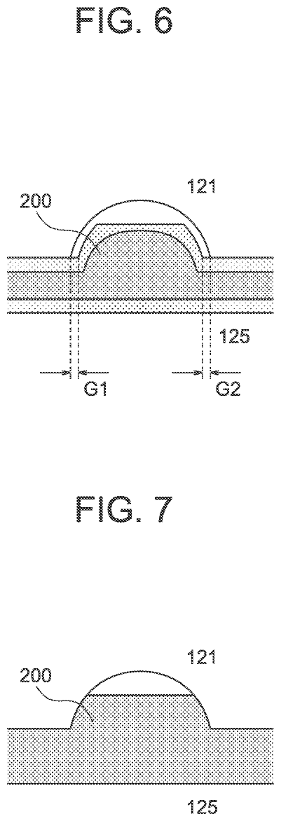

FIG. 6 shows the piece of glass material 200, the upper die 121 and the lower die 125 during a cooling period (step S1020) in a step without pressurizing in a press molding method of a glass optical element according to the present invention. The cooling period described above in a step without pressurizing continues from the point in time t3 to the point in time t4 shown in FIG. 5. During the cooling period, the surface of the piece of glass material 200 is cooled and the temperature of the portion near the surface falls In FIG. 6, the portion near the surface, the portion having a relatively low temperature, is represented schematically by dots less densely distributed and the portion near the center, the portion having a relatively high temperature, is represented schematically by dots more densely distributed.

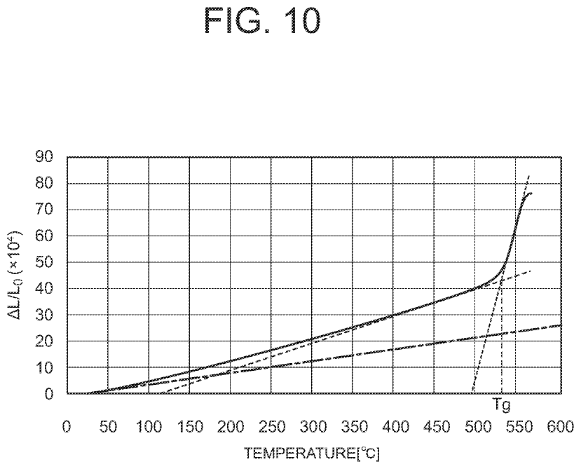

FIG. 10 shows an example of linear expansion of glass and that of a mold. In FIG. 10, the linear expansion of the glass is represented by a solid line and the linear expansion of the mold is represented by an alternate long and short dash line. The horizontal axis of FIG. 10 indicates temperature and the vertical axis of FIG. 10 indicates a ratio of a change in length ΔL to the original unit length L₀ due to a change in temperature. When the change in temperature is represented by ΔT, a coefficient of linear expansion is expressed by the following expression.

$$α = \frac{Δ L}{{L}_{0} \cdot Δ T}$$

According to FIG. 10, the coefficient of linear expansion of the mold is 4.4 (×10⁻⁶) and the coefficient of linear expansion of the glass at a temperature below and near the transition temperature is 110 (×10⁻⁷). Provided that the temperature of the glass material falls by 50 degrees centigrade from the transition temperature, a difference in change in length for the length of 1 millimeter between the glass and the mold due to a difference in coefficient of linear expansion between both of them is (110−44)×50=3300 (×10⁷) millimeters, that is approximately 0.3 millimeters. The difference in change in length due to the difference in coefficient of linear expansion between both of them corresponds to the gap G1 and the gap G2 shown in FIG. 6. Thanks to the gap, the gas in the enclosed space between both of them can be more easily discharged.

Further, according to FIG. 10, the coefficient of linear expansion of the glass remarkably increases when the temperature exceeds the transition temperature.

In general, considering a difference between linear expansion of glass and that of a mold around the transition temperature, a gap between both of them that will be caused by decrease in temperature of 50 degrees centigrade from the temperature in a step with pressurizing is sufficiently great enough to discharge the gas in the enclosed space between both of them. Accordingly, an amount of decrease in temperature of the glass and the mold, the decrease in temperature being caused by cooling, should preferably be 50 degrees centigrade or greater.

FIG. 7 shows the piece of glass material 200, the upper die 121 and the lower die 125 in a step without pressurizing in a conventional press molding method of a glass optical element. In the step without pressurizing in a conventional press molding method, the mold 120 is not cooled and the temperature of the mold 120 is maintained. Accordingly, the temperature inside piece of glass material 200 is uniform. In FIG. 7, the state in which the temperature inside piece of glass material 200 is uniform is schematically represented by dots that are uniformly and densely distributed. Paragraph in Patent document 1 describing a conventional press molding method of a glass optical material describes that a high-pressure gas enclosed between the glass and the mold is discharged to the outside through gas passages between both of them. In the present invention, a difference in thermal contraction between both of them, the thermal contraction being caused by cooling, additionally widens the gap between both of them and therefore the gas in the enclosed space between both of them can be more easily discharged.

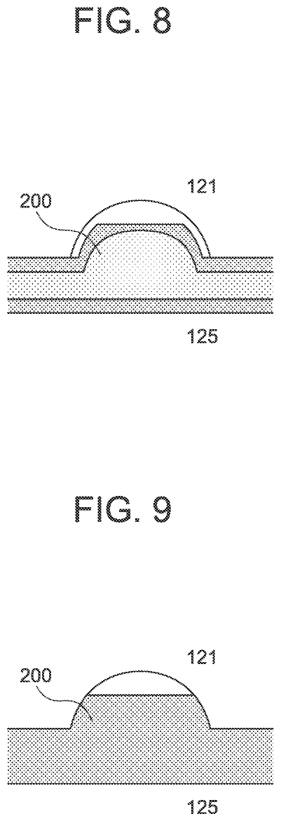

FIG. 8 shows the piece of glass material 200, the upper die 121 and the lower die 125 at the start of step S1040 with pressurizing, that is, at the point in time t1′ in FIG. 5 in a press molding method of a glass optical element according to the present invention. During the heating period after the point in time t4 in FIG. 5, the piece of glass material 200 is heated from the exterior and the temperature of the portion near the surface rises. In FIG. 8 the portion near the surface, the portion having a relatively high temperature, is represented schematically by dots more densely distributed and the portion near the center, the portion having a relatively low temperature, is represented schematically by dots less densely distributed. The temperature of the portion represented by dots more densely distributed is higher than the transition temperature.

By way of example, when the temperature of glass material rises by 50 degrees centigrade and exceeds the transition temperature, the viscosity is supposed to decrease by a factor of 0.1 to 0.01.

The viscosity of the portion represented by dots more densely distributed is lower than that of the portion represented schematically by dots less densely distributed. When load is imposed the piece of glass material 200 in the state shown in FIG. 8, the shape of the portion near the surface represented by dots more densely distributed can be altered more easily than the portion represented by dots less densely distributed. Accordingly, the piece of glass material 200 can be easily molded into the shape of the mold cavity.

FIG. 9 shows the piece of glass material 200, the upper die 121 and the lower die 125 at the start of a step with pressurizing in a conventional press molding method of a glass optical element. In a step without pressurizing in the conventional press molding method, the mold 120 is not cooled and the temperature of the mold 120 is maintained. Accordingly, the temperature inside the piece of glass material 200 is uniform. As a consequence, a state in which the shape of the portion near the surface of the piece of glass material 200 can be relatively easily altered cannot be realized. In FIG. 9, the state in which the temperature inside piece of glass material 200 is uniform is schematically represented by dots that are uniformly and densely distributed.

Experiments in which various values of the amount of change in temperature of the mold 120 between a step with pressurizing and a step without pressurizing are employed for the press molding method were carried out.

Table 1 describes the results of the experiments in which various values of an amount of change in temperature of the mold 120 between a step with pressurizing and a step without pressurizing are employed for the press molding method.

TABLE 1

| | Temperature | Minimum | Amount | |
|---|---|---|---|---|
| | in step | temperature in | of change | |
| | with pres- | step without | in tem- | Evaluation |
| Experi- | surizing | pressurizing | perature | of |
| ment | (° C.) | (° C.) | (° C.) | shape |
| 1 | 540 | 438 | 102 | Good |
| 2 | 540 | 478 | 62 | Good |
| 3 | 540 | 488 | 52 | Acceptable |
| 4 | 540 | 499 | 41 | Unacceptable |

Experiment 1 is the example described with FIG. 5. The amount of change in temperature in Experiment 1 is 102 degrees centigrade. The amounts of change in temperature of Examples 2 to 4 are 62 degrees centigrade, 52 degrees centigrade and 41 degrees centigrade, respectively. By Examples 1 to 3, in each of which the amount of change in temperature was 50 degrees centigrade or greater, optical elements, each of which has a good or an acceptable shape, were obtained. By Example 4, in which the amount of change in temperature was 41 degrees centigrade, an acceptable shape was not obtained due to the residual gas.

Thus, in a press molding method according to the present invention, because of a difference in thermal contraction between the piece of glass material 200 and the mold 120, the thermal contraction being caused by cooling, the gap between both of them is widened and therefore the gas in the enclosed space between both of them can be more easily discharged in a step without pressurizing. Further, in the press molding method according to the present invention, a condition develops, in which the shape of the portion near the surface of the piece of glass material 200 can be relatively easily altered, and therefore the piece of glass material 200 can be easily molded into the shape of the mold cavity.

Through a press molding method according to the present invention, an aspherical lens having the diameter of 1 millimeter, the sag of 0.3 millimeters and the center thickness of 1 millimeter was successfully formed with an accuracy of 0.1 micrometers in P−V value (the value indicating a difference in dimension between a designed lens and a molded lens).

What is claimed is:

1. A press molding method of a glass optical element using a mold, the method including plural steps with pressurizing, in each of which load is imposed on a piece of glass material at a temperature above the glass transition temperature, and a step without pressurizing between two steps with pressurizing,
wherein in a step without pressurizing between a first step with pressurizing and a second step with pressurizing, the second step with pressurizing being the next step with pressurizing after the first step with pressurizing, the temperature of the mold is reduced by 50 degrees centigrade or greater with respect to the temperature of the mold in the first step with pressurizing and then the mold is heated before the start of the second step with pressurizing.

2. The press molding method of a glass optical element according to claim 1, wherein the temperature of the mold is reduced to a temperature below the glass transition temperature in a step without pressurizing.

3. The press molding method of a glass optical element according to claim 1, wherein a value of load imposed in the second step with pressurizing is equal to or greater than a value of load imposed in the first step with pressurizing.

4. The press molding method of a glass optical element according to claim 1, wherein a value of load imposed in the second step with pressurizing is greater than a value of load imposed in the first step with pressurizing.

5. The press molding method of a glass optical element according to claim 1, wherein the temperature of the mold is reduced by an amount that is equal to or smaller than 15 degrees centigrade in a step with pressurizing before transition from the step with pressurizing to a step without pressurizing.
